(19) United States
(12) Patent Application Publication
(10) Pub. No.: US 2018/0375407 A1
(43) Pub. Date: Dec. 27, 2018

(54) SUPPORT ELEMENT, IN PARTICULAR STATOR SUPPORT ELEMENT AND/OR ROTOR SUPPORT ELEMENT, SYSTEM OF SUPPORT ELEMENTS, GENERATOR SUPPORT, GENERATOR, GENERATOR SUPPORT SYSTEM, NACELLE OF A WIND TURBINE, WIND TURBINE AND METHOD FOR ASSEMBLING A GENERATOR SUPPORT SYSTEM

(71) Applicant: Wobben Properties GmbH, Aurich (DE)

(72) Inventor: Florian SARTORIUS, Leer (DE)

(21) Appl. No.: 15/741,449

(22) PCT Filed: Jun. 27, 2016
(86) PCT No.: PCT/EP2016/064874

§ 371 Date: Jan. 2, 2018

(30) Foreign Application Priority Data
Jul. 2, 2015 (DE) 10 2015 212 453.3

(51) Int. Cl. H02K 15/02; H02K 7/18; F03D 15/20

(52) U.S. Cl. CPC H02K 15/028; H02K 7/1838; F03D 80/82; H02K 2213/12; F03D 15/20

(57) ABSTRACT

Provided a support element for a support of a ring generator, in particular a stator support element for a stator support of a ring generator, and/or a rotor support element for a rotor support of a ring generator, wherein, to form the support, a number of support elements are assembled over a generator surface and which support is designed with an outer-circumferential supporting ring for the attachment of a winding and with an inner-circumferential supporting flange for the attachment of a pin for connection to a bed plate. It is provided that the support element has:—a first leg, which is assigned to a first sector of an area of the generator surface and is designed for the assembly of the supporting ring,—a second leg, which is assigned to a second sector of an area of the generator surface and is designed for the assembly of the supporting ring,—the first leg and the second leg adjoining, in particular integrally adjoining, a seat flange that extends over the entire inner circumference and is designed for the assembly of the supporting flange.

### BACKGROUND

### Technical Field

The invention relates to a support element for a support of a ring generator, in particular a stator support element for a stator support of a ring generator, and/or a rotor support element for a rotor support of a ring generator, wherein, to form the respective support, a number of support elements are assembled over a generator surface and which support is designed with an outer-circumferential supporting ring for the attachment of a winding and with an inner-circumferential supporting flange for the attachment of a pin for connection to a bed plate.

### Description of the Related Art

The invention also relates to a system comprising a multielement support with a number of support elements, in particular comprising a stator support and/or a rotor support. The invention also relates to a corresponding generator support.

The invention also relates to a generator and to a nacelle and to a wind turbine and to a method for assembling a generator supporting system.

A wind turbine, in particular a horizontal-axis wind turbine, has proven successful, in particular as a gearless wind turbine. In such a case of a gearless wind turbine—which is explained here at the beginning by way of example, but in principle is not intended to be restrictive for the invention—an aerodynamic rotor directly drives the rotor of a generator, so that the kinetic energy obtained from the wind is converted into electrical energy by interaction of the electromagnetic fields in the generator between the rotor and the stator.

In the case of a gearless wind turbine, the rotor of the generator turns at the speed of the aerodynamic rotor, and consequently with a comparatively slow rotational speed, for which reason such a generator is also referred to as a slow runner. On account of a comparatively high number of poles of the winding, the nominal speed reached with a given feeding frequency is therefore lowered significantly. A slow runner of the aforementioned type with a high number of poles accordingly has a correspondingly great diameter, which may be several meters, which in principle is advantageous. It is problematic in this case however that a slow runner that is provided as the generator for a gearless wind turbine—and to this extent is preferably formed as a synchronous generator—may have a diameter which significantly exceeds widths that are customarily transported by road. Thus, for example, a typical airgap diameter, measured at the air gap between the rotor and the stator, may be ten meters or twenty meters or more, while a maximum width for road transport may for example be only about five meters.

It is known in principle, as described for example in DE 10 2012 208 547 A1, to design an external rotor of a synchronous generator of a gearless wind turbine in a multipart form, while the stator should be undivided.

DE 101 28 438 A1 and DE 100 33 233 A1 disclose various stator supports for a stator of a generator of a wind turbine. Such stator supports are not suitable however for dividing the generator, as desired for transport. Rather, they demand that the generator is completed at the factory on the supports described there and transported in an undivided state.

Thus, the ring generator described in DE 100 33 233 A1 has a stator and a rotor, the stator having a supporting structure by means of which the stator ring and the stator winding are held. The supporting structure is formed by a number of supporting arms consisting of a structure made up of bars.

It is known in principle from DE 100 40 273 A1 to provide a generator arrangement that has at least two stators, with in each case at least one stator winding, each stator winding being assigned at least one electrical phase—preferably consisting of a rectifier, an inverter and a transformer. For example, four stators may be provided, it being possible for each individual stator to be exchanged while the other stators are retained.

The German Patent and Trademark Office has searched the following prior art in the priority application relating to the present PCT application: DE 100 40 273 A1, DE 101 28 438 A1, DE 10 2008 050 848 A1 and DE 10 2012 208 547 A1.

However, with all of the approaches described in the aforementioned documents, it remains problematic that the structural divisions (with regard to the supports) or functional divisions (with regard to the electrical phase) of a generator described therein are already still in need of structural improvement.

### BRIEF SUMMARY

Provided is a support element, a support, in particular a stator support element for a stator support of a ring generator and/or a rotor support element for a rotor support of a ring generator, a system, a generator support, a generator supporting system, and a generator by means of which the aforementioned transporting problems can be solved in an improved way. Preferably, it is intended in addition or possibly as an alternative to this that the structure or the construction of the support can be implemented in an improved way.

In particular, provided is a generator and, on the basis thereof, a support element and a support. Preferably, the generator is designed as a synchronous and slow runner with a comparatively great diameter, in particular a diameter of an air gap of ten meters and more, the object being to design it nevertheless in a comparatively improved way in a dividable state in which it can be transported and/or can be assembled.

In particular, it is intended that a nacelle of a wind turbine can be advantageously assembled. In particular, provided is a corresponding nacelle and a wind turbine that benefit from a support element. In particular, an improved method for assembling a generator supporting system is to be provided, it being intended that transport of a support element and assembly of the generator supporting system are performed in a comparatively simplified manner. In particular, provided is to make the assembly of the support elements at an installation site of a wind turbine and/or the assembly of a supporting system in the nacelle of the wind turbine comparatively simple, in any event to obtain an improvement in comparison with the prior art.

For the support element for a support of a ring generator, in particular the stator support element for a stator support of a ring generator and/or the rotor support element for a rotor support of a ring generator, it is provided that, to form the support, a number of support elements are assembled over a generator surface and which support is designed with an outer-circumferential supporting ring for the attachment of a winding and with an inner-circumferential supporting flange for the attachment of a pin for connection to a bed plate. Also provided is that the support element has:

a first leg, which is assigned to a first sector of an area of the generator surface and is designed for the assembly of the supporting ring,

a second leg, which is assigned to a second sector of an area of the generator surface and is designed for the assembly of the supporting ring,

the first leg and the second leg adjoining, in particular integrally adjoining, a seat flange that extends over the entire inner circumference and is designed for the assembly of the supporting flange.

The invention is based on the idea that, in the case of a support element for forming the support with a number of support elements over a generator surface while assembling the same, until now it has been necessary that an outer-circumferential supporting ring and an inner-circumferential supporting flange must be additionally and subsequently assembled onto a leg of a support element, in a way still in need of improvement.

The invention has recognized that, in the case of the support element, it can be advantageously provided that, to form the support, a number of support elements are assembled over a generator surface and the support is designed with an outer-circumferential supporting ring for the attachment of a winding and with an inner-circumferential supporting flange, in particular for linking up with a pin for connection to a bed plate, in particular for the attachment of a pin.

Accordingly, the concept of the invention with regard to the support element provides:

a first leg, which is assigned to a first sector of an area of the generator surface and is designed for the assembly of the supporting ring,

a second leg, which is assigned to a second sector of an area of the generator surface and is designed for the assembly of the supporting ring,

the first leg and the second leg adjoining a seat flange that extends over the entire inner circumference and is designed for the assembly of the supporting flange.

Accordingly, the concept of the invention with regard to the stator support element provides:

a first stator leg, which is assigned to a first sector of an area of the generator surface and is designed for the assembly of the stator supporting ring,

a second stator leg, which is assigned to a second sector of an area of the generator surface and is designed for the assembly of the stator supporting ring,

the first stator leg and the second stator leg adjoining a stator seat flange that extends over the entire inner circumference and is designed for the assembly of the stator supporting flange.

Accordingly, the concept of the invention concerning the rotor support element provides:

a first rotor leg, which is assigned to a first sector of an area of the generator surface and is designed for the assembly of the rotor supporting ring,

a second rotor leg, which is assigned to a second sector of an area of the generator surface and is designed for the assembly of the rotor supporting ring,

the first rotor leg and the second rotor leg adjoining a rotor seat flange that extends over the entire inner circumference and is designed for the assembly of the rotor supporting flange.

In particular, it is provided that the first and second stator legs integrally adjoin the stator seat flange that extends over the entire inner circumference. In particular, it is provided that the first rotor leg and the second rotor leg integrally adjoin the rotor seat flange that extends over the entire inner circumference.

The concept of the invention also leads to a generator supporting system with such a generator, having:

a bed plate with a receiving pin for supporting the stator, the stator support being attached to the receiving pin by the stator supporting flange that is formed by means of stator seat flanges, and/or

a journal for the attachment of a rotor hub, the rotor support being attached to the rotor hub, in particular by the rotor supporting flange that is formed by means of rotor seat flanges.

The concept of the invention also leads to a nacelle for a wind turbine. The nacelle has a rear nacelle casing and a generator supporting system and also a rotor, comprising the rotor hub, as a continuation of the rear nacelle casing.

The concept of the invention also leads to a wind turbine, which is designed in particular as a gearless wind turbine. The wind turbine has:

a tower with a top flange, and

a nacelle with a generator supporting system, the bed plate being connected to the top flange and the nacelle having a rear nacelle casing, and also

with a rotor comprising a rotor hub as a continuation of the rear nacelle casing.

The concept of the invention also leads to a method for assembling a generator supporting system of the aforementioned type, in which

a stator support and a rotor support of a system for assembly are temporarily connected by way of a mounting block for the formation of a generator support, and

the generator support, in particular as part of a generator, with a temporarily connected stator support and rotor support is attached to a receiving pin of the bed plate,

the stator support being attached to the receiving pin by the stator supporting flange that is formed by means of stator seat flanges, and

the rotor support being attached to the rotor hub, preferably by the rotor supporting flange that is formed by means of rotor seat flanges and a journal receiving the rotor hub in a bearing manner.

The invention has the advantage that, by means of the support elements designed according to the invention, during the assembly of the support, the supporting ring is also assembled at the same time, assembling of the support on a generator supporting system being made comparatively easily possible by the provision of a seat flange that extends over the entire circumference and is adjoined, preferably integrally, by the first leg and the second leg.

In particular, it is therefore provided that, by means of the stator support elements designed according to the invention for the assembly of the stator support and/or rotor support elements designed according to the invention for the assembly of the rotor support, the stator supporting ring or rotor supporting ring is also assembled at the same time, assembling of the stator support or rotor support on a generator supporting system being made comparatively easily possible by the provision of a stator seat flange that extends over the entire inner circumference or a rotor seat flange that extends over the entire inner circumference and is adjoined, preferably integrally, by the first leg and the second leg. That is to say that the first stator leg and the second stator leg adjoin, in particular integrally, a stator seat flange that extends over the entire inner circumference and is designed for the assembly of the stator supporting flange. Or the first rotor leg and the second rotor leg adjoin, in particular integrally, a rotor seat flange that extends over the entire inner circumference and is designed for the assembly of the rotor supporting flange.

Consequently, when assembling the support elements, an additional working step is avoided in that, when assembling the support elements, a corresponding outer-circumferential supporting ring of the support is also assembled. Furthermore, a seat flange that extends over the entire inner circumference is a particularly reliable means of ensuring that the seat flanges are aligned, in particular centered, for the assembly of the supporting flange and are assigned to a pin of the generator supporting system. The seat flange is advantageously already part of a corresponding inner-circumferential supporting flange for linking up with a pin for connection to a bed plate, in particular for the in any event indirect attachment or assignment to a pin.

The support elements according to the concept of the invention also offer the advantage that they can be designed as already weatherproof. This relates in particular to the attachment of a stator winding to the stator supporting ring segment of the stator support element or the attachment of a rotor winding to the rotor supporting ring segment of the rotor support element. This makes it possible to provide a generator which, in the case of a nacelle, between a rotor hub and a rear nacelle casing extends beyond the profile of the nacelle casing thus defined, in other words protrudes from the nacelle.

According to a proposed method for assembling a generator supporting system, the invention offers a comparatively reliable and easy possibility for assembly, the stator support and the rotor support being temporarily connected by way of a mounting block for the forming of a generator support. Preferably, this measure offers the possibility of connecting the mounting block for a time to the stator seat flange of a stator support element and the rotor seat flange of a rotor support element for assembly.

Altogether, the concept of the invention offers the possibility of arranging a support element—that is to say in particular a stator support element or a rotor support element—along a line of a first sector of an area and second sector of an area—in particular a diametrical line of diametrically opposed first and second sectors of an area—on a transporting vehicle, in particular of arranging them longitudinally along the diametrical line. In that case, the support element can nevertheless be provided in a way corresponding to the length of the first and second sectors of an area for a synchronous generator as a slow runner with a comparatively great diameter. In short, a support element, in particular a stator support element or a rotor support element, may well have a length of ten meters, twenty meters or more along the axially arranged first and second sectors of an area. Thus, even with comparatively narrow roads, for example of five meters or less, a support element can be transported separately from other support elements; i.e. a multipart support can be transported after being broken down into its support elements. Nevertheless, the number of support elements can be assembled comparatively easily to form a support. In particular, a number of stator support elements can be assembled comparatively easily to form a stator support or a number of rotor support elements can be assembled comparatively easily to form a rotor support, since during the assembly of the support elements the inner-circumferential supporting ring and the outer-circumferential supporting flange of the support can also be formed at the same time.

Advantageous developments of the invention can be taken from the subclaims and specifically provide advantageous possibilities for realizing the concept explained above within the scope of the object and with regard to further advantages.

For the sake of simplicity, sometimes reference is made hereinafter to a support element, this being understood as meaning a stator support element or a rotor support element or a stator support element and a rotor support element.

Similarly, sometimes reference is made to a support, this being understood as meaning a stator support or a rotor support or a stator support and a rotor support. Similarly, for the sake of simplicity, sometimes reference is made hereinafter to a supporting ring for a stator supporting ring and/or rotor supporting ring or to a supporting flange for a stator supporting flange and/or rotor supporting flange. Similarly, for a stator or rotor, sometimes reference is made hereinafter generally to a leg, supporting arm, supporting ring or supporting ring segment or seat flange.

It has proven to be advantageous within the scope of a development that the first leg has a first radially extending supporting arm and, adjoining the first supporting arm, a first supporting ring segment that extends over the outer circumference, for forming the supporting ring, and the second leg has a second radially extending supporting arm and, adjoining the second supporting arm, a second supporting ring segment that extends over the outer circumference, for forming the supporting ring.

It may be advantageous for the supporting ring to be formed with a mutually turned arrangement of various support elements, and consequently with a circumferential offset of various supporting ring segments.

In particular, it has proven to be advantageous that, additionally or alternatively, a supporting ring segment adjoins, in particular integrally adjoins, one or more supporting arms of the leg. For example, a leg may have one, two, three or more supporting arms—in a way similar to an arrangement of spokes—to which a supporting ring segment is connected in a suitable way, in particular is integrally connected.

Within the scope of a development that is advantageously provided for a support element, in particular a stator support element and a rotor support element, the first sector of an area of the generator surface for forming the supporting ring with the first leg and the second sector of an area of the generator surface for forming the supporting ring with the second leg lie opposite one another in a vertical angle arrangement. To put it another way, the first and second legs or the first sector of an area of the generator surface and the second sector of an area of the generator surface are arranged opposite one another along a diameter line. In principle, a leg may have one, two or more supporting arms. In particular, it has proven to be advantageous that a first stator supporting arm and a second stator supporting arm lie diametrically opposite one another.

In principle, this elongate opposing arrangement of the first and second legs is not mandatory; a first leg and a second leg could for example also be arranged at an angle of 90° in relation to one another; this would in any case improve the transporting situation in comparison with a fully assembled support (in particular a stator support or rotor support).

For example, it has proven to be advantageous that a first supporting arm and a second supporting arm take the form of a flat part covering the first and second sectors of an area. The flat part may for example be formed as a spoked part that has a first and a second supporting arm or more supporting arms.

The angle segment of the full outer-circumferential angle of the supporting ring that is passed over by the supporting ring segment is dependent on how great a number of support elements there are for forming the support. If, for example, as preferred, three support elements—in particular stator support elements for forming a stator support or rotor support elements for forming a rotor support—are provided, it has proven to be advantageous that a first leg and a second leg have in each case three supporting arms, which are respectively adjoined, preferably integrally, at the outer circumference by a supporting ring segment. If, for example, as also preferred, four support elements—in particular stator support elements for forming a stator support or rotor support elements for forming a rotor support—are provided, it has proven to be advantageous that each leg provides two supporting arms, to which a corresponding supporting ring segment is connected, preferably integrally.

In particular, it has proven to be advantageous that, additionally or alternatively, the supporting ring is to be formed with a turned arrangement of various support elements—in particular stator support elements or rotor support elements—and consequently with a circumferential offset of various supporting ring segments. If, for example, a number of three supporting elements is provided for forming a support, each with a first and a second leg, each leg advantageously passes over a sector of the area of the generator surface that corresponds to a circumferential angle of 60°. If, on the other hand, four support elements are provided, each leg advantageously passes over a sector of an area of the generator surface that corresponds to a circumferential angle of 45°.

A supporting ring segment may, but does not have to, be connected in a supporting and secure manner to a laterally neighboring supporting ring segment of another support element during the assembly of the support elements. In particular in the case of a supporting ring segment integrally adjoining a supporting arm, a support element proves however to be sufficiently stable, so that even a gap can remain between the neighboring supporting ring segments after the assembly of the support elements. It is particularly preferably provided in the case of a support element—in particular a stator support element or rotor support element—that the first supporting arm and the second supporting arm adjoin the seat flange that extends over the entire inner circumference, the seat flange fully circumferentially surrounding an opening that serves for receiving the receiving pin along a centering axis. The seat flange that extends over the entire circumference around the opening for receiving the receiving pin can consequently be centered with respect to neighboring seat flanges of a neighboring support element. This offers the possibility of forming the supporting flange for the attachment of a pin in said opening in a particularly preferred way by placing the number of seat flanges next to one another in a way corresponding to the number of support elements along the centering axis. In particular, it has proven to be advantageous that, additionally or alternatively, the seat flange for forming the inner-circumferential supporting flange is to be arranged with a number of seat flanges along the centering axis, the supporting flange being formed with an axial offset of the seat flanges along the centering axis.

Preferably, the seat flange that extends over the entire inner circumference for forming the supporting flange is provided with a centering insert, which is designed to center the seat flange of the support element on another, neighboring seat flange of the number of seat flanges that is axially offset along the centering axis. Particularly preferably, a seat flange has a centering shoulder, by means of which the seat flange can be centered in the axial direction with respect to a first neighboring and/or second neighboring seat flange. For example, it has proven to be advantageous to form the centering insert with a circumferentially extending centering step. The centering step advantageously has a centering shoulder surface running circumferentially and along the centering axis and also a first and a second end stop surface adjoining thereto and extending circumferentially and radially.

The supporting ring segments and centering means on the supporting flange that can already be realized in one set-up can be realized comparatively easily at the factory during the production of a support element.

Depending on the number of support elements, a supporting flange of a support may for example be formed by arranging three, four or more seat flanges in series with one another in the axial direction. Thus, the stator supporting flange may already be formed completely by assembling the stator support elements to form the stator support, in order to attach it to the receiving pin of the bed plate. Thus, the rotor supporting flange may already be formed completely by assembling the rotor support elements to form the rotor support, in order to lead a journal through it, in particular as a bearing.

Specifically, it has proven to be particularly preferable with regard to the stator support that the stator supporting ring is formed with a mutually turned arrangement of the stator support element and a further stator support element, and consequently with a circumferential offset of various stator supporting ring segments, and furthermore the stator seat flange for forming the inner-circumferential stator supporting flange is arranged with a further stator seat flange along the centering axis and centered in relation to one another, the stator supporting flange being formed with an axial offset of the stator seat flange and the further stator seat flange along the centering axis. For example, with the provision of two stator support elements for forming the stator support, the arrangement of two stator seat flanges centered in relation to one another, or generally of two seat flanges in relation to one another, a supporting flange can be formed.

Specifically, it has proven to be particularly preferable with regard to the rotor support that the rotor supporting ring is formed with a mutually turned arrangement of the rotor support element and a further rotor support element, and consequently with a circumferential offset of various rotor supporting ring segments, and furthermore the rotor seat flange for forming the inner-circumferential rotor supporting flange is arranged with a further rotor seat flange along the centering axis and centered in relation to one another, the rotor supporting flange being formed with an axial offset of the rotor seat flange and the further rotor seat flange along the centering axis. For example, with the provision of two rotor support elements for forming the rotor support, the arrangement of two rotor seat flanges centered in relation to one another, or generally of two seat flanges in relation to one another, a supporting flange can be formed.

With regard to the stator support element, it has proven to be particularly advantageous that the first and second stator supporting arms are adjoined by a stator supporting ring segment that is in the form of a bordering frame and T-shaped in cross section, in particular centrally. This measure has proven to be particularly advantageous for forming a stator support to be arranged within the rotor support.

In particular, this measure is advantageous for the case where the rotor is provided as an external rotor on the generator.

Accordingly, it has also proven to be advantageous that the first and second rotor supporting arms are adjoined by a rotor supporting ring segment that is in the form of a bordering frame and L-shaped in cross section, in particular laterally. To this extent, the rotor support can, in graphic terms, be of an approximately pot-like design, by the stator support being inserted while leaving an air gap. The aforementioned developments with regard to the stator support element and rotor support element concerning the arrangement of the bordering frame take these ideas into account in a particularly preferred way.

In particular, it has proven to be advantageous that the seat flange has circumferentially arranged first openings for receiving mounting screws, which are intended for attachment and removal again, that is to say in particular temporarily for transportation and/or assembly, that is to say generally as an auxiliary screwing means. Furthermore, a seat flange additionally or alternatively has circumferentially arranged second openings for operating screws, which are intended as a main screwing means to be retained during the operation of the generator, that is to say for the reception and the attachment and retention of operating screws. The development has recognized that it is particularly advantageous for assembly screws and operating screws to be attached in the seat flange, since this can be implemented easily and with comparatively great stability.

With regard to the system comprising a multielement stator support with a number of stator support elements and/or a multielement rotor support with a number of rotor support elements, it has proven to be particularly advantageous that each of the support elements can be removed from another support element and attached again. In particular, each of the support elements can be removed from another support element and attached again with an electrical generator function of its own. In particular, it can be ensured in this way that, even with the electrical generator function, the support elements can be transported separately.

For providing a generator function, it has already proven to be advantageous if the support elements have corresponding windings on the supporting ring and the connection cabling and the pole packs.

With regard to the generator support, it has proven to be advantageous that a number of at least two, three or four or more stator supports or a number of three or four or more rotor supports or a number of two, three or four or more stator supports and a number of at least two, three or four or more rotor supports are provided.

In particular, it is also possible that the generator support is formed with a number of at least two, three or four stator supports, in combination with an undividable, that is to say in particular single-element, rotor support. In particular, it has proven to be advantageous that a number of at least two, three or four rotor supports is formed in combination with an undividable, in particular single-element, stator support. Such a development takes into account that, if appropriate, a stator or rotor should be transported in an undivided state, if it tends to be advantageous to form it completely as a single element at the factory.

With regard to the generator, it has accordingly proven to be particularly advantageous that each of the stator support elements and rotor support elements is designed with an electrical connection of its own, which is provided for making available its own operational generator function. The concept of the invention consequently extends not only to stator support elements or rotor support elements as mentioned above, but also to stator elements or rotor elements comprising in each case a support element and the associated complete generator function with the corresponding windings and electrical connections. To this extent it is ensured that a generator with for example at least two, three or four or more stator elements and at least two, three or four or more rotor elements is already operational even when only one of the stator elements and rotor elements is operational.

Within the scope of a particularly preferred development, it may be provided for the generator that on each of the stator support elements with a stator winding and/or on each of the rotor support elements with a rotor winding, that is to say for the purpose of an own operational generator function, in each case an own operational connection is provided to a power supply connection for the own operational generator function. In particular, it is provided for the operational connection that in each case a rectifier, a DC conductor, an inverter and a transformer are connected to a stator element, that is to say a stator support element with a stator winding and/or a rotor element, that is to say a rotor support element with a rotor winding.

With regard to the generator supporting system, it has proven to be particularly advantageous that the stator supporting flange formed by means of the stator seat flange is arranged directly between the receiving pin and the journal. In particular, it has proven to be advantageous that the stator supporting flange formed by means of the stator seat flange is flanged-in at both end faces of the stator supporting flange, between the receiving pin and the journal. In particular, it has proven to be advantageous that, as a result, the journal is connected in a continuous manner by way of the stator supporting flange to the receiving pin of the bed plate. In other words, the stator supporting flange formed by the stator seat flanges is further formed in the structural progression of the bed plate to the receiving pin and then to the journal by way of the stator supporting flange. And this has advantages, since, in particular in consideration of the aforementioned centering, the bed plate can be assembled up to the journal with the generator supporting system without further adjustment.

In particular, it has proven to be advantageous in an alternative that the stator supporting flange formed by means of the stator seat flange is fitted directly on the receiving pin, in particular securely surrounds the receiving pin of the bed plate. This alternative development is likewise realistic, in particular within the scope of the centering development, and can be regarded as an alternative to the integration of the stator supporting flange between the receiving pin and the journal.

Advantageously, the supporting flange formed by means of the rotor seat flange can be attached indirectly to the rotor hub and the journal can be surrounded by it in a freely rotatable manner.

The invention offers in an advantageous way the basis for a development of the nacelle with the generator supporting system, it being possible for the generator supporting system with the generator to be surrounded by the nacelle casing and the rotor hub.

In principle, the support elements, in particular a stator element or rotor element with corresponding windings, can also be of a weatherproof design, so that the generator supporting system can be surrounded by the nacelle casing, the generator protruding between the rotor hub and the rear nacelle casing.

Within the scope of the method, it has proven to be particularly advantageous that the rotor hub is pre-mounted on the journal for the forming of a hub bearing arrangement. This can in particular take place at the factory.

It is also provided within the scope of the development of the method that the hub bearing arrangement with the journal is placed onto the receiving pin of the bed plate. This considerably simplifies the assembly at the installation site of the wind turbine if, as mentioned, the hub bearing arrangement is already pre-mounted on the journal.

Subsequently, the number of rotor blades for forming the rotor can be fitted onto the blade flange bearings of the rotor hub. Advantageously, the rotor hub has three blade flange bearings for three rotor blades.

Within the scope of the method, the generator is advantageously fitted as a synchronous generator for a gearless wind turbine in the form of a ring generator.

Exemplary embodiments of the invention are now described below on the basis of the drawing. The drawing is not necessarily intended to show the exemplary embodiments to scale, but rather takes a schematized and/or slightly distorted form wherever this is useful for explanatory purposes. For additions to the teachings that are directly evident from the drawing, reference is made to the relevant prior art. At the same time, it must be taken into account that a wide variety of modifications and changes relating to the form and detail of an embodiment can be made without departing from the general concept of the invention. The features of the invention that are disclosed in the description, in the drawing and in the claims may be essential to the development of the invention both individually and in any desired combination. Moreover, the scope of the invention covers all combinations of at least two of the features disclosed in the description, the drawing and/or the claims. The general concept of the invention is not limited to the exact form or the detail of the preferred embodiment shown and described below or limited to a subject matter that would be restricted in comparison with the subject matter defined in the claims. Where dimensional ranges are specified, values lying within the stated limits are also intended to be disclosed as limit values and able to be used and claimed as desired. For the sake of simplicity, the same designations are used below for parts that are identical or similar or parts that have an identical or similar function.

### BRIEF DESCRIPTION OF THE SEVERAL VIEWS OF THE DRAWINGS

Further advantages, features and details of the invention emerge from the following description of the preferred exemplary embodiments and on the basis of the drawings, in which specifically:

FIG. 1 shows the basic construction of a wind turbine with a tower and a nacelle, in the present case as a gearless wind turbine with a synchronous generator as a slow runner in the form of a ring generator, within the scope of a particularly preferred embodiment;

FIG. 2 shows a longitudinal section through the nacelle of the wind turbine of FIG. 1 including representation of the generator supporting system with a generator, that is to say in particular with a top flange of the tower, a bed plate, a receiving pin and a journal and a rotor hub mounted on it, it being possible for a stator supporting flange of a stator support of the generator to be introduced between the receiving pin and the journal, according to a preferred embodiment;

FIG. 3 shows a perspectively simplified representation of the generator supporting system as explained with reference to FIG. 2, with the generator according to a preferred embodiment, of which only the generator support between the receiving pin on the bed plate and the journal with the rotor hub is shown;

FIG. 4 shows a simplified representation of the top flange of the tower with the bed plate and the receiving flange as explained with reference to FIG. 3;

FIG. 5 shows a simplified representation of the partially assembled generator supporting system of FIG. 4, the stator supporting flange thereof that is shown, of the stator support of the generator, being flanged-in between the receiving pin and the journal, according to a preferred embodiment;

FIG. 5A, FIG. 5B and FIG. 5C show a perspective representation of a turned arrangement of various stator support elements, in the present case three, and consequently with a circumferential offset of the various stator supporting ring segments of the stator supporting ring, the stator seat flange for forming the inner-circumferential stator supporting flange being arranged with a number of stator seat flanges along the centering axis, with an axial offset of the number of stator seat flanges along the centering axis;

FIG. 6 shows an exploded drawing for further explanation of the turned arrangement shown in FIG. 5A, FIG. 5B and FIG. 5C of various stator support elements, and consequently the formation of the stator supporting ring with a circumferential offset of various stator supporting ring segments, the number of stator seat flanges, in the present case three, being arranged along the centering axis for forming the inner-circumferential stator supporting flange;

FIG. 7 shows an exploded drawing for further explanation of the insertion of the stator support with a bordering frame adjoining the supporting arms in a T-shaped manner into an approximately pot-shaped rotor support with a bordering frame adjoining the supporting arms in an L-shaped manner;

FIG. 8 shows in an exploded drawing the operation of flanging the generator support onto a receiving pin of the bed plate, the rotor support and the stator support only being secured to one another by an auxiliary screwing means temporarily for this mounting operation;

FIG. 9 shows in an exploded drawing the operation of flanging the journal with a hub bearing arrangement onto the generator support, which is attached to the receiving pin, the stator supporting flange being flanged-in on both sides between the receiving pin and the journal;

FIG. 10 shows another perspectively simplified representation of the generator supporting system as explained with reference to FIG. 3;

FIG. 11 shows a particularly preferred representation of a stator support element in a detail of the first stator leg and with a stator seat flange—this analogous to a rotor support element;

FIG. 12 shows in a sectional representation along the centering axis the flanged-in stator seat flanges for forming a stator supporting flange between the receiving pin and the journal of a generator supporting system as represented with reference to FIG. 6 and FIG. 7;

FIG. 13 shows a flow diagram for carrying out an assembling method for a generator supporting system with reference to FIG. 6 to FIG. 12;

FIG. 14(A) shows an exploded drawing for representing a mounting sequence of a generator support;

FIG. 14(B) shows a sectional representation, similar to FIG. 12, along the centering axis including representation of a stator supporting flange with stator seat flanges placed against one another and extending over the entire circumference and a rotor supporting flange with rotor seat flanges placed against one another and extending over the entire circumference along the centering axis, an auxiliary screwing means and a mounting block being depicted between the stator support and the rotor support;

FIG. 14(C) shows an auxiliary screwing means that is already represented in FIG. 14(B) in plan view;

FIG. 15 shows an auxiliary screwing means that is shown in FIG. 14(B) and (C), which as far as the stator support is concerned is replaced by a main screwing means;

FIG. 16 shows a perspective sectional view through a stator supporting flange and a rotor supporting flange in the case of the stator support and rotor support of FIG. 16, with the auxiliary screwing means removed and main screwing means attached.

### DETAILED DESCRIPTION

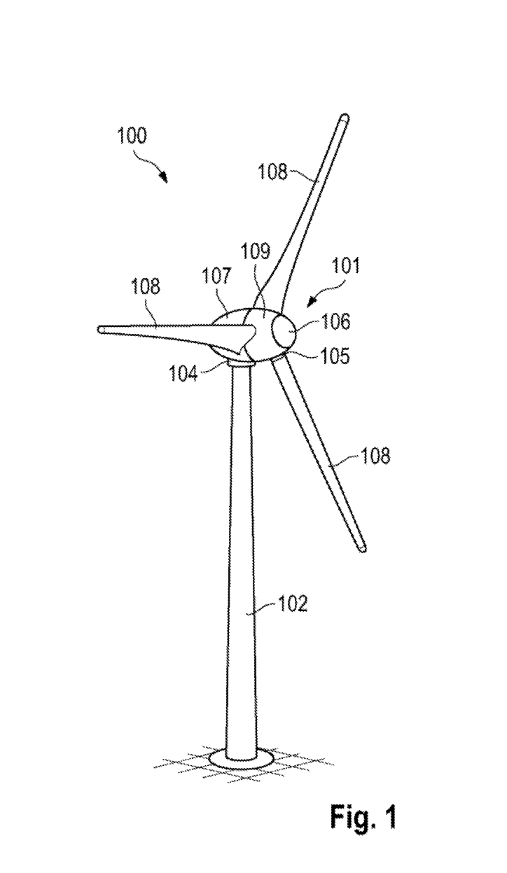

FIG. 1 shows a wind turbine 100 in a perspective view with a tower 102 and a nacelle 101, which is arranged on the tower 102 and has a rotor hub 109 with three rotor blades 108. The nacelle 101 also has a rear nacelle casing 107, which adjoins the rotor hub 109 and surrounds the non-rotating part of the nacelle 101 that is not shown any more specifically; that is to say for instance the bed plate explained further below, the generator, the power electronics, etc.; according to a preferred embodiment, the generator, with a correspondingly large diameter—for instance with the outer circumferential region of the rotating rotor (external rotor)—may in this case also protrude from the nacelle 101 between the rotor hub 109 and the adjoining rear nacelle casing 107.

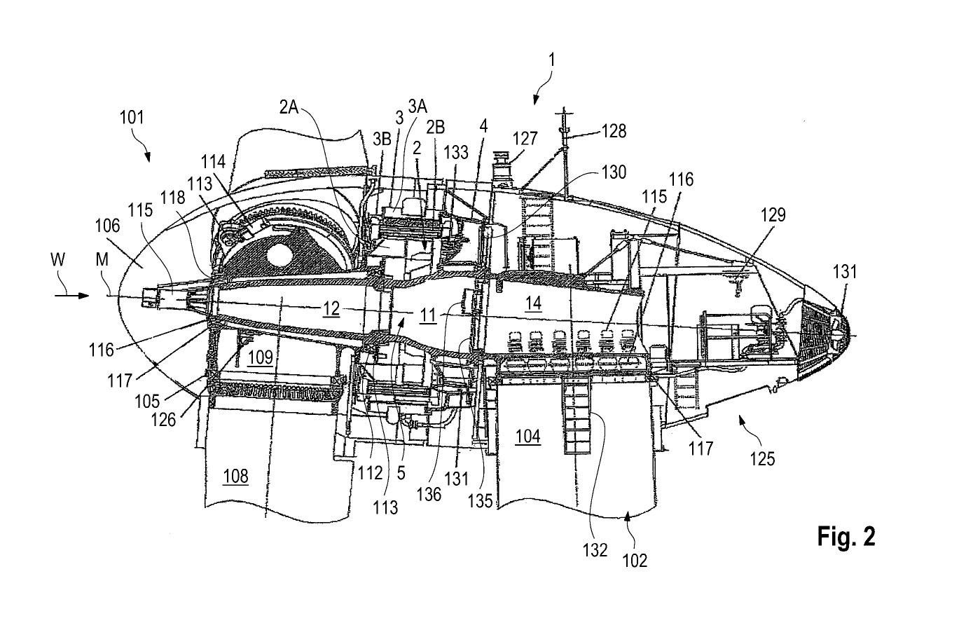

Also shown on the rotor hub is a so-called spinner casing 106, which is directed as intended into the wind. The region of the spinner casing 106 is also referred to as the front part of the nacelle 101 or the front nacelle casing. To this extent, the nacelle 101 is divided in principle between a front region of the spinner casing 106, the rotor hub 109 and a rear region of the rear nacelle casing 107. In the region where the rotor blades 108 are attached, a rotor blade root is attached to a blade flange bearing 105, which holds a rotor blade 108 in a way that is indicated more specifically in FIG. 2.

The tower 102 has a top flange 104, onto which a bed plate 14 indicated more specifically in FIG. 2 is fitted, in order to provide and make available the internals that are accommodated in the nacelle 101, in particular here the generator supporting system 5, the generator 1 and various power electronics, etc.

Not shown in detail in FIG. 1 are the usual electrical devices for the connection of a wind turbine to a public supply system and the various power electronics, such as rectifiers, DC conductors, inverters and transformers—these may be accommodated as appropriate in the nacelle 101, in the tower 102 or separately from that in a switch cabinet in the direct vicinity of the wind turbine 100 or (for example in the case of a wind farm or an offshore wind turbine) in a switch cabinet that is comparatively remote from the wind turbine 100.

FIG. 2 shows the basic construction and the internals of the nacelle 101, which for this purpose is shown in a sectional view along a longitudinal section; along an axis M, which corresponds essentially to an oncoming wind direction W. The internals and attachments of the nacelle 101 that are shown in FIG. 2 essentially comprise the following elements: a rotor blade 108, a blade flange bearing 105, a blade adjusting gear mechanism 113, a blade adjusting motor 114, a slipring assembly 115, an axial cover 116, a front bearing cover 117, a double-row tapered roller bearing 118 and the aforementioned rotor hub 109. The slipring assembly 115 is in the present case accommodated within the spinner casing 106.

A generator supporting system 5 has a journal 12, a receiving pin 11 and a bed plate 14 on the top flange 104 of the tower 102. Also depicted are a cylindrical roller bearing 112, a rear bearing cover 113 and an azimuth bearing arrangement with an azimuth motor 115, an azimuth gear mechanism 116, an azimuth bearing 117 and also the aforementioned tower 102 with the aforementioned top flange 104.

The nacelle 101 additionally has a central lubricating system 126, approach lighting 127 and a combined wind sensor 128. An electric chain hoist 129 allows equipment to be transported into the nacelle 101 or out from it through a load hatch 125 below; the electric chain hoist has a load-bearing capacity of for example 250 kilograms.

One of the ways in which the nacelle 101 can be accessed is via the tower 102, that is to say by way of an entry ladder 132, which reaches from the tower 102 to the nacelle 101. For this purpose, an entry hatch that is not indicated any more specifically is provided through the top flange 104 of the tower 102.

For ventilating the nacelle 101, it has a nacelle fan 130 and a passive tail fan 131.

The journal, receiving pin and bed plate 10, 11, 14 serve as a generator supporting system for receiving and supporting a generator 1 that is explained in more detail below. The generator 1 is designed in the present case as a ring generator in the form of a slow running synchronous generator. The rotor 2 of the generator 1 may be fixed in relation to the stator by means of an electromagnetic brake caliper 131 and an arresting means 133; for example to fix the rotor 3 in relation to the stator 2 for servicing purposes.

The generator 1 shown in FIG. 2 is formed as a ring generator with a rotor 3 and a stator 2. The rotor 3 has a rotor support 3A, on which a rotor winding 3B has been applied to pole packs. The stator 2 has a stator support 2A, on which a stator winding 2B has been applied to stator packs. The stator 2 is secured by means of a stator bell 4 to the receiving pin 11, which in turn is attached to the bed plate 14. The rotor 3 is connected to the rotor hub 109 and turns along with it, the rotor hub 109 being mounted in a rotating manner on the journal 12 by means of said tapered roller bearings 118 and cylindrical roller bearings 112. The generator 1 is consequently formed as an external-rotor generator with an inner-lying stator and an outer-lying rotor 2, 3. The arrangement of a bed plate 14 with a flanged-on receiving pin and journal 11, 12 to this extent forms a generator supporting system 5, attached to the top flange 104 of the tower 102, for the generator 1 or with the generator 1. The rotor support 3A is to this extent supported indirectly by the journal 12; the stator support 2A is to this extent supported directly by the receiving pin 11.

The generator supporting system 5 is in the present case of a hollow design and is arranged along a center axis M. The center axis M to this extent forms an axis of rotation for the rotor 3 and a central axis for the journal 12, the receiving pin 11 and the bed plate 14 Also provided in the receiving pin is an insert 135 with a blower 136 in the receiving pin 11. The blower 136 can consequently move the air into the interior space of the generator supporting system 5 comprising the bed plate 14, the receiving pin 11 and the journal 12.

The generator supporting system 5 with the generator 1 is shown as a supporting system 10 with the generator 1 on the bed plate 14 with the receiving pin 11 and the journal 12. The rotor hub 109 mounted on the journal 12 is in this case depicted with the blade flange bearings 105 for the rotor blades 108 of the rotor.

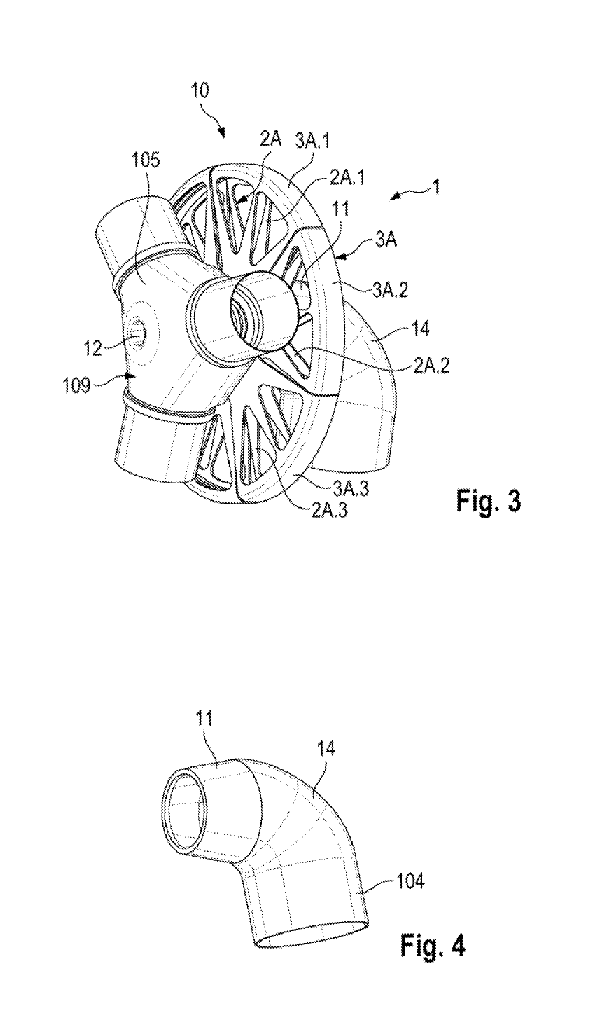

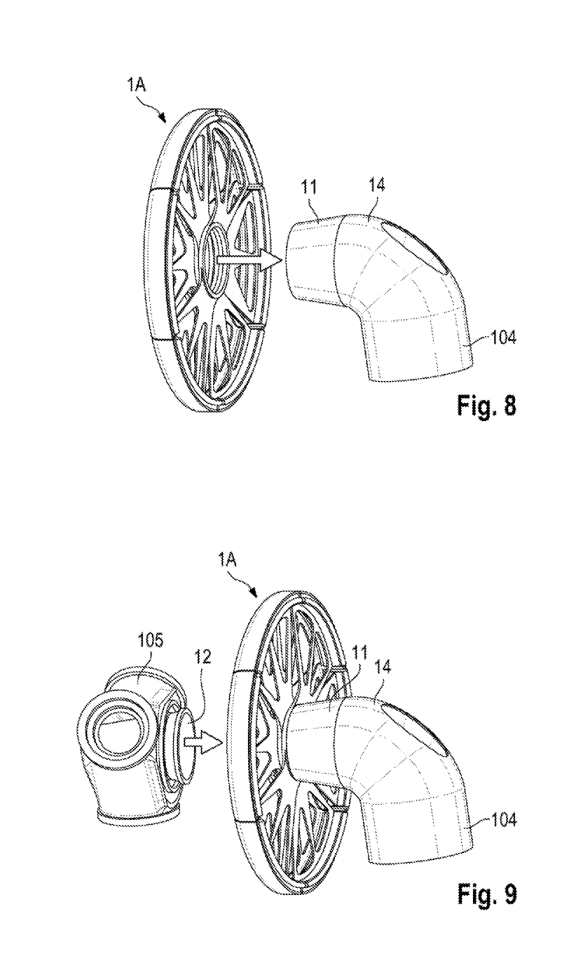

It can also be seen that the generator 1 with the rotor 3 and the stator 2 is shown with the assigned stator support 2A and rotor support 3A. Each of the supports 2A, 3A is formed with a number of stator support elements 2A.1, 2A.2, 2A.3 or rotor support elements 3A.1, 3A.2, 3A.3 that are shown more specifically in FIG. 3. This construction is specifically explained in principle on the basis of the following FIG. 4 to FIG. 7; details are explained with reference to FIG. 8 to FIG. 12. An assembling method for the generator support is explained in FIG. 13 to FIG. 16.

Specifically, FIG. 3 and FIG. 4 show in this respect the top flange 104 of the tower 102 with the bed plate 14 fitted on it and the receiving pin 11 flanged on it. The receiving pin 11 is to this extent flanged-on at the end face of the bed plate 14.

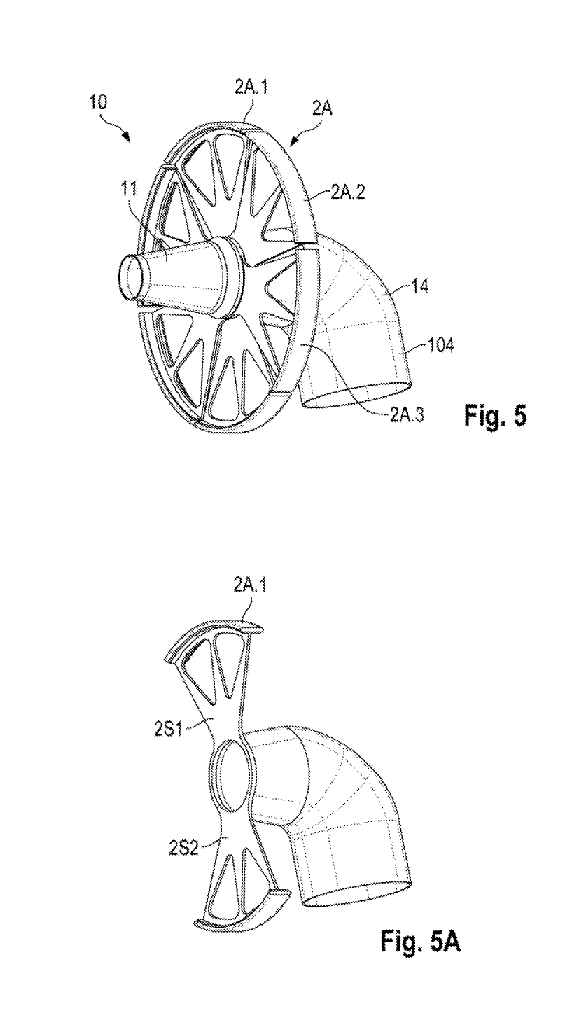

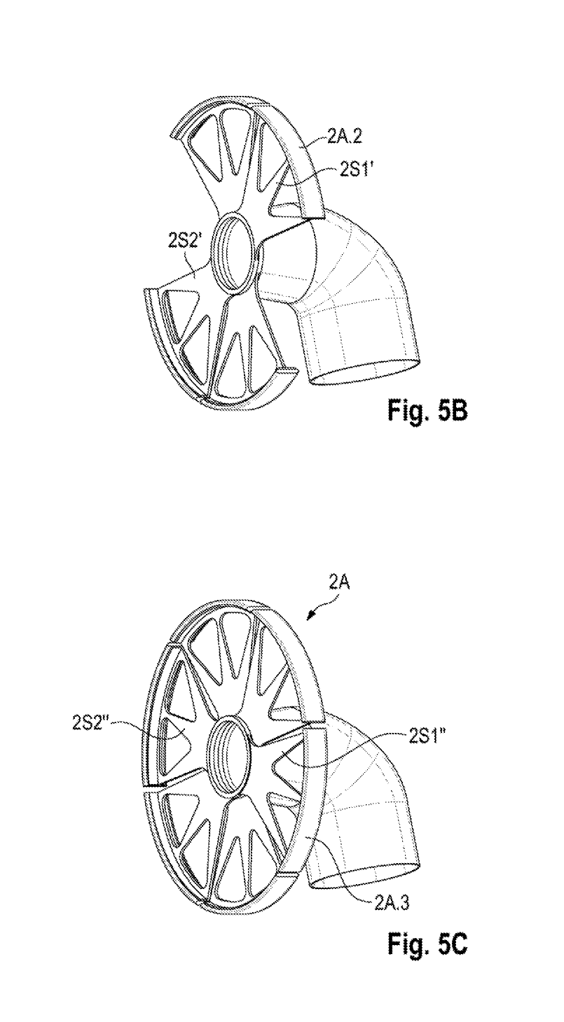

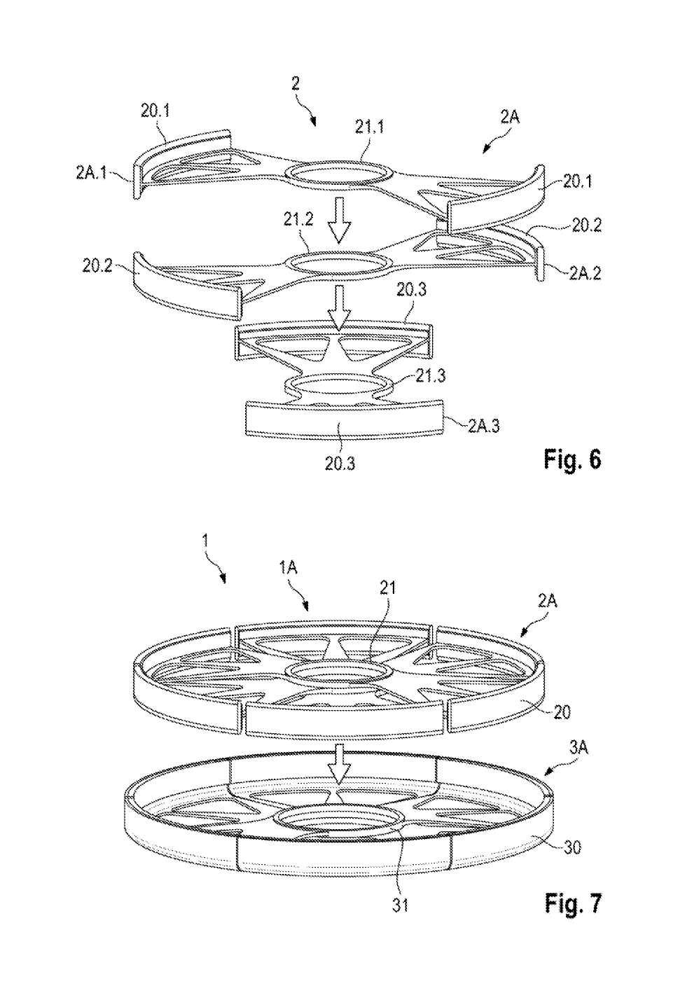

As can be seen from FIG. 5, the stator support 2A is flanged-in on both sides between the receiving pin 14 and the journal 11, the number of stator support elements 2A.1, 2A.2, 2A.3 being immediately evident, in the present case three, which are arranged turned in relation to one another. Very similarly, as can already be seen from FIG. 3, the number of rotor support elements 3A.1, 3A.2, 3A.3, in the present case three, are arranged turned in relation to one another. Very similarly, FIG. 6 shows the assembling of rotor support elements 3A.1, 3A.2 and 3A.3.

As far as the stator support 2A is concerned, this is explained in more detail specifically on the basis of the sequence of FIG. 5A, FIG. 5B and FIG. 5C. As shown in FIG. 5A, a first stator support element 2A.1 with a first stator leg 2S1 and a second stator leg 2S2, in each case covering an angle of 60°, is initially arranged in a six to twelve o'clock position. Attached at a clock position turned by a further 60° of the further stator legs 2S1′, 2S2′ is a structurally identical second stator support element 2A.2 and, as can be seen from FIG. 5C, attached at a four to eleven o'clock position of the still further stator legs 2S1″, 2S2″ is a third structurally identical stator support element 2A.3.

The placing of the stator support 2A of the stator 2 into the rotor support 3A of the rotor 3 for forming the generator support 1A for a generator 1 is shown in FIG. 7.

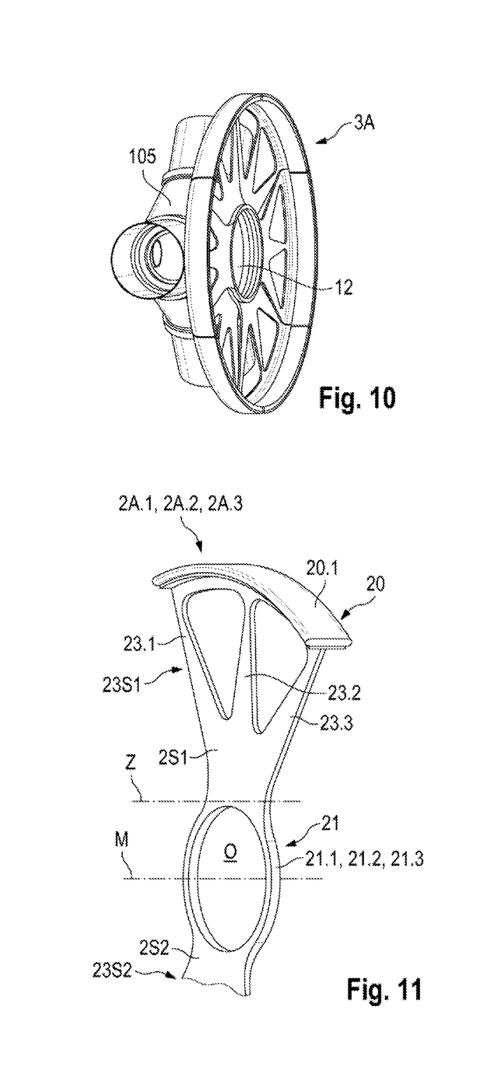

The generator support 1A thus formed is flanged according to FIG. 8 in front of the receiving pin 11 and according to FIG. 9 is flanged-in between the receiving pin 11 and the journal 12 with the rotor hub 105. The rotor hub 105 is shown in FIG. 10 with the bearing-mounted journal 12 and the external-rotor support 3A attached to it.

FIG. 11 shows specifically the construction of a stator support element 2A.1, 2A.2, 2A.3, these stator support elements 2A.1, 2A.2, 2A.3 being formed as structurally almost identical. FIG. 11 is also exemplary for the construction of a rotor support element 3A.1, 3A.2, 3A.3, these rotor support elements 3A.1, 3A.2, 3A.3 being formed as structurally almost identical and—as can be seen in FIG. 7—deviating from the stator support elements 2A.1, 2A.2, 2A.3 essentially only in the formation of the rotor supporting ring 30 in comparison with the stator supporting ring 20.

Each of the stator support elements 2A.1, 2A.2, 2A.3, and by analogy the rotor support elements 3A.1, 3A.2, 3A.3, is consequently obtained as follows.

The stator support element 2A.1, 2A.2, 2A.3 shown in FIG. 11 is designed as one of three structurally identical stator support elements for a stator support 2A of a ring generator 1, wherein, to form the stator support 2A, the stated number of stator support elements 2A.1, 2A.2, 2A.3 are assembled over a generator surface that is determined essentially by the cross section of the generator. Specifically, a stator surface corresponds approximately to the circular area as correspondingly provided by the bordering of the stator 2 or the area of the stator support 2A, for example as can be seen especially in FIG. 7. As can be seen especially in FIG. 7, the stator support 2A has an outer-circumferential stator supporting flange 20 for the attachment of a stator winding 2B indicated in FIG. 7 and FIG. 2. The stator support 2A also has an inner-circumferential stator supporting flange 21, which is designed for the attachment of a receiving pin 11 to the bed plate 14. As can be seen especially in FIG. 7, the rotor support 3A has an outer-circumferential rotor supporting flange 30 for the attachment of a rotor winding 3B indicated in FIG. 7 and FIG. 2. The rotor support 3A also has an inner-circumferential rotor supporting flange 31, which is designed for leading through and bearing on a journal 12.

The stator support element 2A.1, 2A.2, 2A.3 then partially depicted in FIG. 11—by analogy a rotor support element 3A.1, 3A.2, 3A.3 with a corresponding designation of the features specific to a rotor 3—also has the following elements:

a first stator leg 2S1, which a first sector of an area which is assigned to a previously explained generator surface, the sector of an area being formed essentially by the outer bordering of the first leg 2S1. The first stator leg 2S1 is designed for the assembly of the stator supporting ring 20. Furthermore, the stator support element has a second stator leg 2S2, which is only partially shown in FIG. 11. This is assigned to a second sector of an area of the generator surface and is likewise designed for the assembly of the stator supporting ring 20. Both the first stator leg 2S1 and the second stator leg 2S2 are connected to one of the stator seat flanges 21.1, 21.2, 21.3 that extend over the entire inner circumference, the assembly of the stator seat flanges 21.1, 21.2, 21.3 being shown in FIG. 6 together with the stator support element 2A.1, 2A.2, 2A.3. In this case, the stator legs 2S1, 2S2 are integrally connected respectively to the stator seat flange 21.1 of the stator support element 2A.1 or the stator seat flange 21.2 of the stator support element 2A.2 or the stator seat flange 21.3 of the stator support element 2A.3. The stator seat flange 21.1 is formed with the further stator seat flanges 21.2, 21.3, as shown in FIG. 6 for the assembly of the stator supporting flange 21.

In order to assemble the stator supporting ring 20 as explained, thus in the present case each of the stator support elements 2A.1, 2A.2, 2A.3 is equipped with said first and second stator legs 2S1, 2S2, which for the sake of simplicity are designated the same here for each of the stator support elements 2A.1, 2A.2, 2A.3. The first stator leg 2S1 has a first radially extending stator supporting arm 23S1, in the present case three spokes of the stator supporting arm that are designated by 23.1, 23.2, 23.3 being formed. The second stator leg 2S2 has a second radially extending stator supporting arm 23S2, in the present case three spokes of the stator supporting arm that are not shown but are also designated here by 23.1, 23.2, 23.3 being formed.

The first stator supporting arm 23S1 is adjoined, in the present case once again integrally, by a first stator supporting ring segment 20.1 that extends over the outer circumference and in the case of the other stator support elements 2A.2, 2A.3 is correspondingly designated by 20.2, 20.3. The stator supporting ring segments 20.1, 20.2, 20.3 serve for forming the stator supporting ring 20. Accordingly, the second stator leg 2S2 has a second radially extending stator supporting arm 23S2 that is not shown any further and a second stator supporting ring segment 20.1 that extends over the outer circumference and adjoins, also in the present case integrally, the second stator supporting arm 23S2 for forming the stator supporting ring 20. These stator supporting ring segments 20.1, 20.2, 20.3, which for the sake of simplicity are designated the same and are not shown in FIG. 11, also serve for forming the stator supporting ring 20.

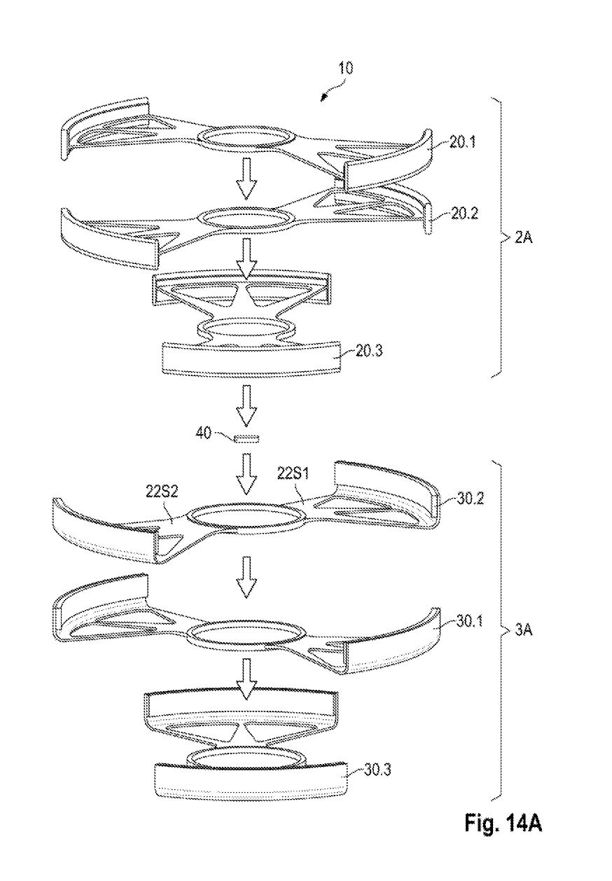

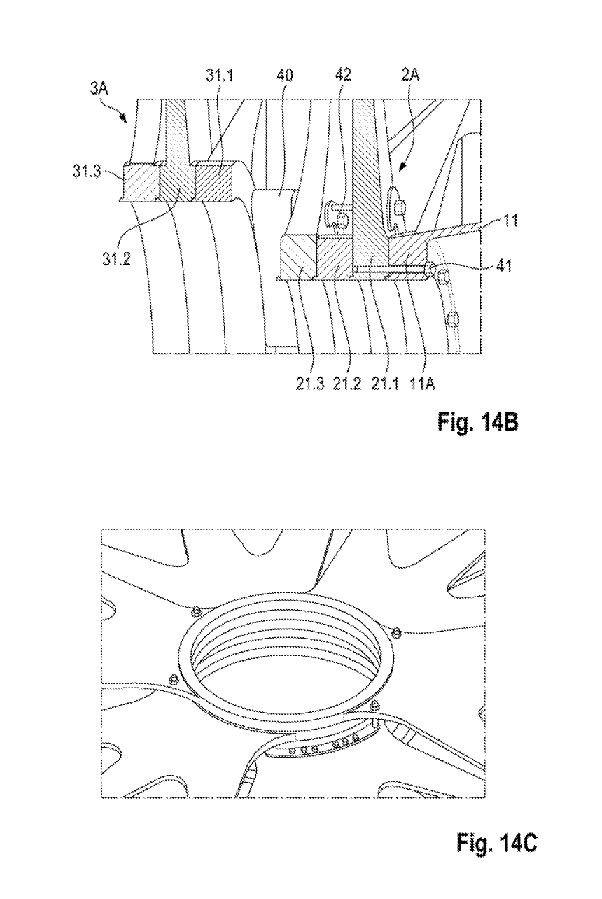

In other words, a first and a second stator supporting arm 23 take the form of a flat spoked part that covers the first and second sectors of an area and have the spokes 23.1, 23.2, 23.3. Attached to the first and second stator supporting arms 23 is in each case a stator supporting ring segment 20.1, 20.2, 20.3. A stator supporting ring segment 20.1, 20.2, 20.3 takes the form of a bordering frame and, as can be seen in FIG. 11, is T-shaped in cross section and integrally connected centrally. A similar situation applies for the rotor support 3A, wherein, as can be seen from FIG. 14(A), the first and second rotor supporting arms 22S1, 22S2 are adjoined centrally and integrally by a rotor supporting ring segment in the form of a bordering frame that is L-shaped in cross section.

To form the stator supporting ring 20, the stator supporting ring 20 is thus formed with a turned arrangement of the three said stator support elements 2A.1, 2A.2, 2A.3, and consequently with a circumferential offset of the various pairs of stator supporting ring segments 20.1, 20.2, 20.3—that is to say as can be seen in the exploded drawing of FIG. 6.

To form the rotor supporting ring 30, the rotor supporting ring 30 is thus formed with a turned arrangement of the three said rotor support elements 3A.1, 3A.2, 3A.3, and consequently with a circumferential offset of the various pairs of rotor supporting ring segments 30.1, 30.2, 30.3—that is to say as can be seen in the exploded drawing of FIG. 14(A).

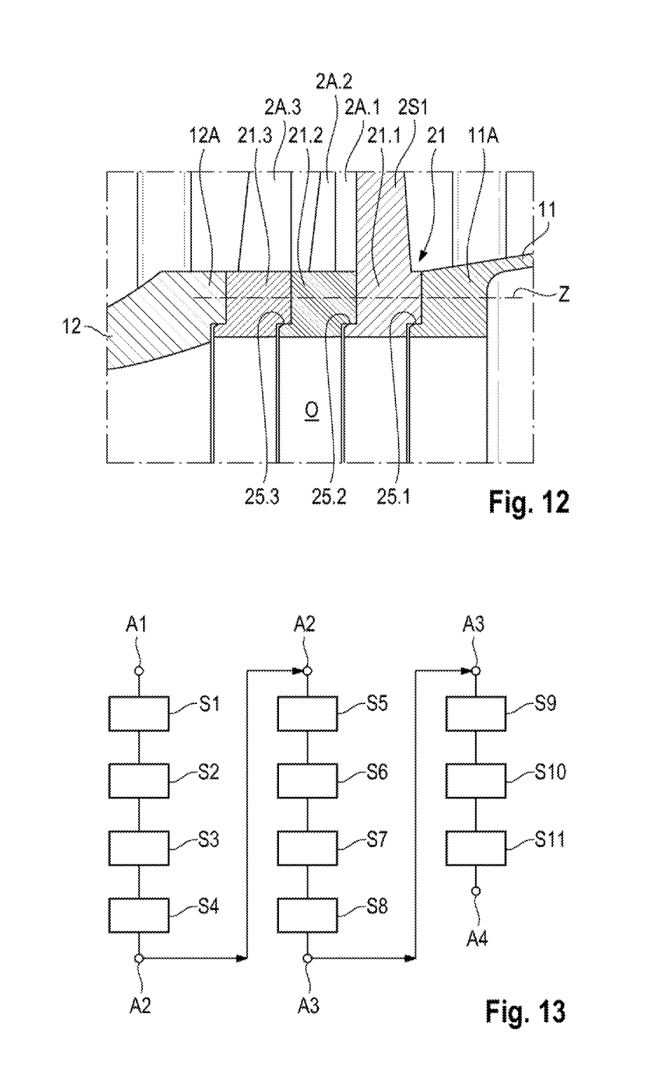

Furthermore, as represented in detail in FIG. 12, to form the stator supporting flange, it is provided that the first stator supporting arm 23S1 and the second stator supporting arm 23S2 as explained adjoin the stator seat flange 21.1 or 21.2 or 21.3, respectively, that extends over the entire inner circumference in a way corresponding to the stator support elements 2A.1, 2A.2, 2A.3. In this case, the stator seat flange 21.1, 21.2, 21.3 surrounds a central opening that is designated by O and serves for receiving the receiving pin 11 along a centering axis Z, parallel to a central center axis M. In this case, the receiving pin 11 may extend within the opening O or else—as shown in FIG. 12 as a preferred embodiment—adjoin the end face of the stator supporting flange 21 on one side.

Accordingly, in FIG. 12 the connection flange 11A of the receiving pin 11 is shown on the end face of the stator supporting flange 21 that is on the right there and in FIG. 12 the receiving flange 12A of the journal 12 is shown on the end face of the stator supporting flange 21 that is on the left there.

The stator supporting flange 21 is thus made up of a sequence of stator seat flanges 21.1, 21.2, 21.3, arranged along the centering axis Z (parallel to the central center axis M), of the stator support elements 2A.1, 2A.2 and 2A.3 forming these stator seat flanges 21.1, 21.2, 21.3. Of these, in the present case the first stator leg 2S1 can be seen, at least in cross section, as explained above.

Consequently, the stator seat flanges 21.1, 21.2, 21.3 that extend over the inner circumference are already formed onto a stator support element 2A.1, 2A.2, 2A.3, with an axial offset along the centering axis Z for forming the stator supporting flange 21.

In order to center the stator seat flanges 21.1, 21.2, 21.3 with respect to one another, each of the same has a centering shoulder, in the present case in the form of a circumferentially extending centering step 25.1 25.2, 25.3. The centering step 25.1, 25.2, 25.3 consequently has an outer radial section along the centering axis Z and a circumferentially extending centering shoulder surface at the location of the designation 23.1, 23.2, 23.3 which can be seen in FIG. 12. To put it another way, the centering shoulder surface 25.1, 25.2, 25.3 extends in the direction of the centering axis Z. The stepped surfaces proceeding from it along the radius of a stator seat flange 21.1, 21.2, 21.3 lead over onto a further depicted inner radial section along the centering axis Z. In the present case, the centering shoulder surface of the centering step 25.1, 25.2, 25.3 is beveled in an angled-away part in relation to the centering axis Z. This makes possible a simplified placement of the stator support elements 2A.1, 2A.2, 2A.3 on top of one another, and consequently centering while they are being placed one on top of the other, in this sequence onto the connection flange 11A of the receiving pin 11 and the subsequent fitting of the receiving flange 12A of the journal 12, as shown in section in FIG. 12.

As can also be seen in FIG. 11, the first sector of an area of the generator surface for forming the stator supporting ring 20 with the first stator leg 2S1 and the second sector of an area of the generator surface for forming the stator supporting ring 20 with the second stator leg 2S2 therefore lie opposite one another in a vertical angle arrangement. In the present case, it is additionally provided that a first stator supporting arm 23.1 and a second stator supporting arm 23.1 of the second leg 2S2 are diametrically opposite. This applies correspondingly to diametrically opposite stator supporting arms 23.2 of the legs 2S1, 2S2 and the stator supporting arms 23.3 of the legs 2S1, 2S2.

Furthermore, as already explained, a rotor support element 3A.1, 3A.2, 3A.3 with a corresponding designation of the features specific to a rotor 3 is constructed in a way analogous to a stator support element 2A.1, 2A.2, 2A.3 of FIG. 11 and FIG. 12.

FIG. 13 shows in a flow diagram the basic method steps for assembling a generator supporting system 5, as can already be seen from FIG. 2 and FIG. 3 and the further figures.

The assembling method consequently provides in a first step S1 that the stator support is assembled as a multielement stator support 2A with a number of stator support elements 2A.1, 2A.2, 2A.3, as explained in detail on the basis of FIG. 11 and FIG. 12. Furthermore, in a further step S2, the rotor support is assembled as a multielement rotor support 3A with a number of rotor support elements 3A.1, 3A.2, 3A.3, as can be seen in FIG. 14(A).

As can be seen in FIG. 7 and FIG. 14(A), consequently a system comprising a multielement stator support 2A and a multielement rotor support 3A is initially formed for providing a multielement generator support 10. According to step S3, this generator support is designed in such a way that the stator support 2A and the rotor support 3A are connected by way of a mounting block 40, which is shown in FIG. 14(B).

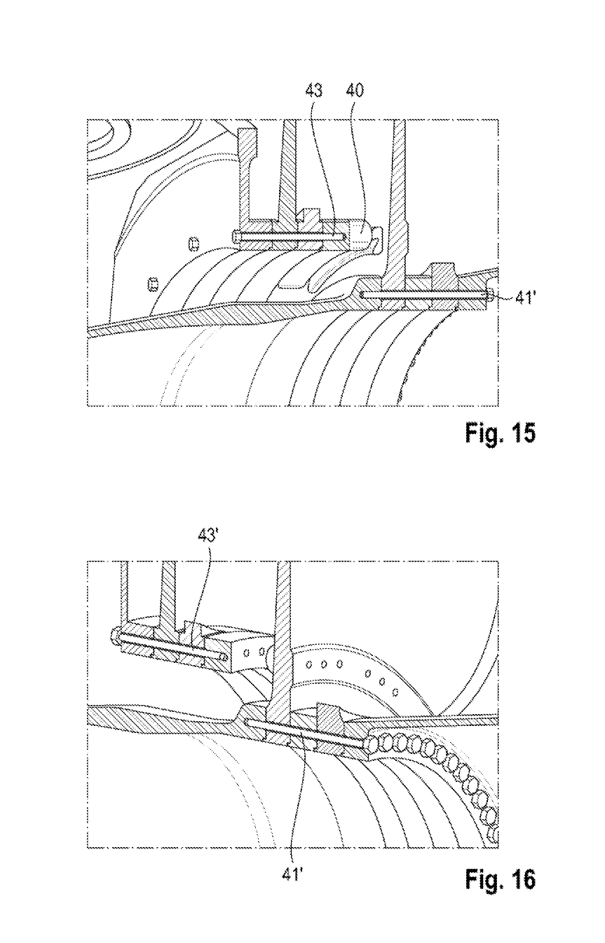

In a method step S4, which is represented in FIG. 14(B), the multielement stator support 2A is also initially fastened to the connection flange 11A of the receiving pin 11 by way of a fixing screw 41. The stator support elements 2A.1, 2A.2, 2A.3, which can be seen in FIG.14(B) by their stator seat flanges 21.1, 21.2, 21.3, are fixed in relation to one another and are held on the mounting block 40 by way of a mounting screwing means 42, in the same way as the rotor support elements 3A.1, 3A.2, 3A.3, which can be seen by rotor seat flanges 31.1, 31.2, 31.3, are held on the mounting block 40 by way of the auxiliary screwing means 42—this can also be seen in FIG. 15 and in the plan view of FIG. 14(C).

In a further step S5, the system of a generator support 1A fixed in this way is then attached in the way evident from FIG. 8 with the stator supporting flange 21 by its one end face onto the receiving pin 11. Subsequently, in a further step S6, as can be seen in FIG. 9 and FIG. 12, the rotor hub 105 is attached with the journal 12 to the stator supporting flange 21 by its other end face. Finally, as can be seen in FIG. 10, in a further step S7, the rotor blades 108 of the rotor are attached to the rotor hub 105, so that this results in a construction such as that which can be seen assembled in FIG. 3 as a generator supporting system 5.

However, in a further step S8, the auxiliary screwing means that can be seen in FIG. 15 for the stator 2 or the stator support 2A is first replaced by an operating screwing means 41′, which is shown in FIG. 15 and FIG. 16. Furthermore, in a step S9, the auxiliary screwing means 42 and the mounting block 40 are removed. Finally, in a further step S10, the auxiliary screwing means 43 are replaced by an operating screwing means 43′ for the rotor, which is shown in FIG. 16.

This finally produces the operationally ready generator system on the basis of the generator supporting system 5 of FIG. 3 for a wind turbine of FIG. 1 and FIG. 2 in a step S11.

1. A support element for forming a support of a ring generator, the support element comprising:
an outer-circumferential supporting ring for attachment of a winding,
an inner-circumferential supporting flange for linking up with a pin for connection to a bed plate,
a first leg that is assigned to a first sector of an area of the generator surface and is designed for assembly of a supporting ring, and
a second leg that is assigned to a second sector of an area of the generator surface and is designed for the assembly of the supporting ring,
the first leg and the second leg adjoining a seat flange that extends over the entire inner circumference and is designed for the assembly of the supporting flange.

2. The support element as claimed in claim 1, wherein the support element is a stator support element for forming a stator support, wherein to form the stator support, a plurality of stator support elements are assembled over a generator surface.

3. The support element as claimed in claim 2 wherein:
the first leg has a first radially extending stator supporting arm and a first stator supporting ring segment that extends over the outer circumference and is coupled to the first stator supporting arm for forming the supporting ring,
the second leg has a second radially extending stator supporting arm and a second stator supporting ring segment that extends over the outer circumference and is coupled to the second stator supporting arm for forming the supporting ring, and
the supporting ring is to be formed with a turned arrangement of various stator support elements, and consequently with a circumferential offset of various stator supporting ring segments.

4. The support element as claimed in claim 2, wherein:
the first stator supporting arm and the second stator supporting arm integrally adjoin the seat flange that extends over the entire inner circumference, the seat flange fully circumferentially surrounding an opening that serves for receiving the receiving pin along a centering axis, and
the seat flange for forming the inner-circumferential supporting flange is to be arranged with a plurality of seat flanges along the centering axis, while the supporting flange is to be formed with an axial offset of the plurality of seat flanges along the centering axis.

5. The support element as claimed in claim 4, wherein the seat flange has a centering shoulder is designed to center the seat flange of the stator support element on another, neighboring seat flange of the plurality of seat flanges that is axially offset along the centering axis for forming the stator supporting flange.

6. The support element as claimed in claim 5, wherein the centering shoulder is formed with a centering step that extends circumferentially along the seat flange and has a centering shoulder surface that extends circumferentially and along the centering axis and also a first and second circumferentially and radially extending end stop surface adjoining thereto.

7. The support element as claimed in claim 2, wherein the first sector of an area of the generator surface for forming the supporting ring with the first leg and the second sector of an area of the generator surface for forming the supporting ring with the second leg lie opposite one another in a vertical angle arrangement.

8. The support element as claimed in claim 2, wherein the first stator supporting arm and a second stator supporting arm lie diametrically opposite one another.

9. The support element as claimed in claim 2, wherein the first stator supporting arm and a second stator supporting arm are a flat part covering the first and second sectors of an area.

10. The support element as claimed in claim 2, wherein the first and second stator supporting arms are adjoined by a stator supporting ring segment that is a bordering frame and T-shaped in cross section.

11. The support element as claimed in claim 2, wherein the seat flange
has circumferentially arranged first openings for receiving mounting screws that are configured for attachment and removal, and
has circumferentially arranged second openings for receiving operating screws that are configured for attachment and retention.

12. The support element as claimed in claim 1, wherein the support element is a rotor support element for forming a rotor support, wherein to form the rotor support, a plurality of rotor support elements are assembled over a generator surface.

13. The support element as claimed in claim 12, wherein the first leg has a first radially extending rotor supporting arm and a first rotor supporting ring segment that extends over the outer circumference and is coupled to the first rotor supporting arm for forming the supporting ring, wherein:
the second leg has a second radially extending rotor supporting arm and a second rotor supporting ring segment that extends over the outer circumference and is coupled to the second rotor supporting arm for forming the supporting ring, and
the supporting ring is to be formed with a turned arrangement of rotor support elements, and consequently with a circumferential offset of first and second rotor supporting ring segments.

14. The support element as claimed in claim 12, wherein:
the first rotor supporting arm and the second rotor supporting arm integrally adjoin the seat flange that extends over the entire inner circumference, the seat flange fully circumferentially surrounding an opening that serves for receiving the receiving pin along a centering axis, and
the seat flange for forming the inner-circumferential rotor supporting flange is to be arranged with a plurality of seat flanges along the centering axis, while the rotor supporting flange is to be formed with an axial offset of the plurality of seat flanges along the centering axis.

15. The support element as claimed in claim 14, wherein
the seat flange has a centering shoulder is designed to center the seat flange of the support element on another, neighboring seat flange of the plurality of seat flanges that is axially offset along the centering axis for forming the rotor supporting flange.

16. The rotor support element as claimed in claim 15, wherein the centering shoulder is formed with a circumferentially extending centering step that has a centering shoulder surface that extends circumferentially and along the centering axis and also a first and second circumferentially and radially extending end stop surface adjoining thereto.

17. The support element as claimed in claim 12, wherein the first sector of an area of the generator surface for forming the supporting ring with the first leg and the second sector of an area of the generator surface for forming the supporting ring with the second leg lie opposite one another in a vertical angle arrangement.

18. The support element as claimed in claim 12, wherein a first rotor supporting arm and a second rotor supporting arm lie diametrically opposite one another.

19. The support element as claimed in claim 12, wherein a first rotor supporting arm and a second rotor supporting arm are a flat part covering the first and second sectors of an area.

20. The support element as claimed in claim 12, wherein the first and second rotor supporting arms are adjoined by a supporting ring segment that is a bordering frame and L-shaped in cross section.

21. The support element as claimed in claim 12, wherein the rotor seat flange has circumferentially arranged:
first openings for receiving mounting screws that are configured for attachment and removal again, and
second openings for receiving operating screws that are configured for attachment and retention.

22. (canceled)

23. The support element as claimed in claim 12, wherein each of the rotor support elements can be removed from each other and attached again with an electrical generator function of its own.

24. A generator support comprising a stator support and a rotor support as claimed in claim 12, wherein the rotor support circumferentially surrounds the stator support.

25. A generator support comprising:
at least two, three or four stator supports, or
at least two, three or four rotor supports, or
at least two, three or four stator supports and at least two, three or four rotor supports.

26. A ring generator of a synchronous generator, comprising a generator support as claimed in claim 24, the stator support carrying a stator winding with a plurality of stator pole packs, and the rotor support carrying a rotor winding with a plurality of rotor pole packs.

27. The generator as claimed in claim 26, wherein each of the rotor support elements is designed with an electrical connection of its own.

28. The generator as claimed in claim 26, wherein:
for an operational generator function of its own, to each of the stator support elements with a stator winding and/or to each of the rotor support elements with a rotor winding
there is respectively connected a rectifier, a DC conductor, an inverter and a transformer, for forming in each case an own operational connection to a power supply connection for the own operational generator function.

29. A generator supporting system with a generator as claimed in claim 26, comprising:
a bed plate with a receiving pin for supporting the stator, the stator support being attached to the receiving pin by the stator supporting flange that is formed by stator seat flanges, and
a journal for the attachment of a rotor hub, the rotor support being attached to the rotor hub by the rotor supporting flange that is formed by means of rotor seat flanges.

30. The generator supporting system as claimed in claim 29, wherein the stator supporting flange formed by the stator seat flanges is flanged-in at both end faces of the stator supporting flange, directly between the receiving pin and the journal, wherein the journal is connected in a continuous manner by way of the stator supporting flange to the receiving pin of the bed plate.

31. The generator supporting system as claimed in claim 29, wherein
the stator supporting flange formed by the stator seat flanges is fitted directly on the receiving pin and securely surrounds the receiving pin of the bed plate, and
the rotor supporting flange formed by the rotor seat flanges is attached indirectly to the rotor hub and surrounds the journal in a freely rotatable manner.

32. A nacelle of a wind turbine comprising a rear nacelle casing and with a generator supporting system as claimed in claim 29 and a rotor comprising the rotor hub as a continuation of the rear nacelle casing.

33. The nacelle as claimed in claim 32, wherein the generator supporting system with the generator is surrounded by the nacelle casing and the rotor hub.

34. The nacelle as claimed in claim 32, wherein the generator supporting system is surrounded by the nacelle casing, the generator protruding between the rotor hub and the rear nacelle casing.

35. A wind turbine comprising:
a tower with a top flange, and
a nacelle with a generator supporting system as claimed in claim 29, the bed plate being connected to the top flange and the nacelle having a rear nacelle casing, and
a rotor comprising a rotor hub as a continuation of the rear nacelle casing.

36. The wind turbine as claimed in claim 35, wherein the wind turbine is a gearless wind turbine, and wherein the generator is a synchronous generator as a slow runner and a ring generator.

37-38. (canceled)

39. The support element as claimed in claim 1, wherein the first leg and the second leg integrally adjoining the seat flange.

40. The support element as claimed in claim 1, wherein the support element is assembled with a plurality of support elements to form the support of the ring generator.
